(19) United States
(12) Patent Application Publication
(10) Pub. No.: US 2012/0290484 A1
(43) Pub. Date: Nov. 15, 2012

(54) Method and System for Sending Surveys and Receipts Electronically to Customers Purchasing with Credit Cards

(76) Inventor: Joel M. Maher, Holly Springs, NC (US)

(21) Appl. No.: 13/107,280

(22) Filed: May 13, 2011

(51) Int. Cl. G06Q 10/00; H04L 9/28; G06Q 20/00

(52) U.S. Cl. 705/71; 705/7.32; 705/16

(57) ABSTRACT

A system and method provide customers making purchases with a credit card with electronically delivered receipts and surveys from the merchant. A user subscribes to the system and provides credit card information and an electronic message address (e.g. and email address or mobile phone number). The system does not store the entire credit card information. Upon a purchase, a credit card processor forwards credit card information to the system. A related message address is identified. A survey previously created by the merchant is transmitted to the address. The customer receives the receipt and survey. The customer completes the survey and submits it to the system. The system forwards the survey results to the merchant.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to electronic delivery of receipts, surveys, and other information to customers purchasing with credit cards.

2. Description of the Related Art

A review of credit cards is provided.

A credit card is a thin plastic card, usually 3⅛ inches by 2⅛ inches in size that contains identification information such as a signature and sometimes a photograph. A bank authorizes the person named on the credit card to charge purchases or services to an account. Some information on the card can be read by a merchant without a machine.

Under a traditional bank credit-card system, the bank credits the account of the merchant as sales slips are received and assembles charges to be billed to the cardholder at the end of the billing period. In turn, the cardholder pays the bank either the entire balance or in monthly installments with interest (sometimes called carrying charges).

Although phone companies, gas companies and department stores have their own numbering systems, ANSI Standard X4.13-1983 is the system used by most national credit-card systems.

The first digit in a credit-card number signifies the system: 3—travel/entertainment cards (such as American Express and Diners Club), 4—Visa, 5—MasterCard, and 6—Discover Card. The structure of the card number varies by system. For example, American Express card numbers start with 37; Carte Blanche and Diners Club with 38.

In American Express accounts, digits three and four are type and currency. Digits five through eleven are the account number. Digits twelve through fourteen are the card number within the account and digit fifteen is a check digit.

In Visa accounts, digits two through six are the bank number, digits seven through twelve or seven through fifteen are the account number and digit thirteen or sixteen is a check digit.

In MasterCard accounts, digits two and three, two through four, two through five or two through six are the bank number (depending on whether digit two is a “1”, “2”, “3” or other). The digits after the bank number up through digit fifteen are the account number. Digit sixteen is a check digit.

The back of a credit card includes a horizontal magnetic stripe. The back of the card includes a signature panel for an authorized user to write a signature.

The stripe on the back of a credit card is a magnetic stripe, often called a magstripe. The magstripe is made up of tiny iron-based magnetic particles in a plastic-like film. Each particle is really a tiny bar magnet about twenty-millionths of an inch long.

The stripe of magnetic material (hereinafter “magstripe”) can be “written” because the tiny bar magnets can be magnetized in either a north or south pole direction.

A magstripe reader can read the information on the three-track stripe. Most magstripe read errors are caused by a dirty or scratched magstripe or an erased magstripe. The most common causes for erased magstripes are exposure to magnets.

There are three tracks on the magstripe. Each track is about one-tenth of an inch wide. The ISO/IEC standard 7811, which is used by banks, specifies: track one is two hundred ten (210) bits per inch (bpi), and holds seventy nine (79) 6-bit plus parity bit read-only characters. Track two is seventy five (75) bpi, and holds forty (40) 4-bit plus parity bit characters. Track three is 210 bpi, and holds 107 4-bit plus parity bit characters.

Currently, a credit card typically uses only tracks one and two. Track three is a read/write track (which includes an encrypted PIN, country code, currency units and amount authorized), but its usage is not standardized among banks.

The information on track one is contained in two formats: A, which is reserved for proprietary use of the card issuer, and B, which includes the following: start sentinel—one character, format code=“B”—one character (alpha only), primary account number—up to nineteen (19) characters, separator—one character, country code—three characters, name—two to twenty-six (26) characters, separator—one character, expiration date or separator—four characters or one character, discretionary data—enough characters to fill out maximum record length (seventy-nine (79) characters total), end sentinel—one character, and longitudinal redundancy check (LRC)—one character. LRC is a form of computed check character.

The format for track two, developed by the banking industry, is as follows: start sentinel—one character, primary account number—up to 19 characters, separator—one character, country code—three characters, expiration date or separator—four characters or one character, discretionary data—enough characters to fill out maximum record length (40 characters total), and LRC—one character.

There are three basic methods for determining whether a credit card will pay for what you're charging: merchants with few transactions each month do voice authentication using a touch-tone phone, electronic data capture (EDC) magstripe-card swipe terminals are becoming more common—so is swiping your own card at the checkout, and virtual terminals on the Internet.

Credit card processing follows the following system. After a credit card is swiped through a reader, the Electronic Data Capture (EDC) software at the point-of-sale (POS) terminal dials a stored telephone number (using a modem) to call an acquirer. An acquirer is an organization that collects credit-authentication requests from merchants and provides the merchants with a payment guarantee.

When the acquirer company gets the credit-card authentication request, it checks the transaction for validity and the record on the magstripe for Merchant ID, valid card number, expiration date, credit-card limit, and card usage.

Single dial-up transactions are processed at twelve hundred (1,200) to twenty-four hundred (2,400) bits per second (bps), while direct Internet attachment uses much higher speeds. For some transactions, the cardholder enters a personal identification number (PIN) using a keypad.

The PIN is not on the card—it is encrypted (hidden in code) in a database. (For example, before withdrawing cash from an ATM, the ATM encrypts the PIN and sends the PIN to the database to see if there is a match.) The PIN can be either in the bank's computers in an encrypted form (as a cipher) or encrypted on the card itself. The transformation used in this type of cryptography is called one-way. This means that it's easy to compute a cipher given the bank's key and the customer's PIN, but not computationally feasible to obtain the plain-text PIN from the cipher, even if the key is known. This feature was designed to protect the cardholder from being impersonated by someone who has access to the bank's computer files.

Likewise, the communications between the ATM and the bank's central computer are encrypted to prevent would-be thieves from tapping into the phone lines, recording the signals sent to the ATM to authorize the dispensing of cash and then feeding the same signals to the ATM to trick the ATM into unauthorized dispensing of cash.

There are now cards that utilize even more security measures than conventional credit cards: Smart Cards.

The “smart” credit card utilizes cryptography. A smart card has a microprocessor built into the card itself. The user must corroborate his identity to the card each time a transaction is made, in much the same way that a PIN is used with an ATM. The card and the card reader execute a sequence of encrypted sign/countersign-like exchanges to verify that each is dealing with a legitimate counterpart. Once this has been established, the transaction itself is carried out in encrypted form to prevent anyone, including the cardholder or the merchant whose card reader is involved, from “eavesdropping” on the exchange and later impersonating either party to defraud the system. This elaborate protocol is conducted in such a way that it is invisible to the user, except for the necessity of entering a PIN to begin the transaction. The chips in these cards are capable of many kinds of transactions. For example, purchases can be made from a credit account, debit account, or from a stored account value that's reloadable. The enhanced memory and processing capacity of the smart card is many times that of traditional magnetic-stripe cards and can accommodate several different applications on a single card. It can also hold identification information, track participation in an affinity (loyalty) program, or provide access to an office.

Card security codes (CSC) are used to enhance the security of credit cards. The CSC can be located on the back or front of the credit card. Typically, the CSC is a printed group of 3 digits to the right of the signature strip. The card security code (CSC), sometimes called Card Verification Data (CVD), Card Verification Value (CVV or CVV2), Card Verification Value Code (CVVC), Card Verification Code (CVC or CVC2), Verification Code (V-Code or V Code), or Card Code Verification (CCV) are different terms for security features for credit or debit card transactions, providing increased protection against credit card fraud.

There are several types of security codes. The first code, called CVC1 or CVV1, is encoded on the magnetic stripe of the card and used for transactions in person. The purpose of the CVC1 or CVV1 is to ensure the data stored on the magnetic stripe of the card is valid and was generated by the issuing bank. This value is submitted as part of transactions and is verified by the issuing bank. A limitation of the CVC1 or CVV1 is that if the entire magnetic stripe is copied, rather than generated, the card can be duplicated. The second code, and the most cited, is CVV2 or CVC2. This CSC (also known as a CCID or Credit Card ID) is often asked for by merchants for them to secure card not present transactions occurring over the Internet, by mail, fax or over the phone. In many countries in Western Europe, due to increased attempts at card fraud, it is now mandatory to provide this code when the cardholder is not present in person. Contactless card and chip cards may supply their own codes generated electronically, such as iCVV or Dynamic CVV. These codes should not be confused with the standard card account number appearing in embossed or printed digits. These codes should also not be confused with a card's PIN. These codes are not printed or embedded in the card but are manually entered at the time of transaction.

Because the CSC is not contained on the magnetic stripe of the card, it is not typically included in the transaction when the card is used face to face at a merchant. Requiring the CSC provides a level of protection to the bank/cardholder, in that a corrupt merchant cannot simply capture the magnetic stripe details of a card and use them later for “card not present” purchases over the phone, mail order or Internet. To do this, a merchant would also have to note the CVV2 visually and record it, which is more likely to arouse the cardholder's suspicion. Merchants who require the CVV2 for “card not present” transactions are forbidden in the USA by Visa from storing the CVV2 once the individual transaction is authorized and completed. This way, if a database of transactions is compromised, the CVV2 is not included, and the stolen card numbers are less useful. The Payment Card Industry Data Security Standard (PCI DSS) also prohibits the storage of CSC (and other sensitive authorization data) post transaction authorization. This applies globally to anyone who stores, processes or transmits card holder data.

Supplying the CSC code in a transaction is intended to verify that the customer has the card in their possession. Knowledge of the code proves that the customer has seen the card, or has seen a record made by somebody who saw the card.

CVC1, CVV1, CVC2 and CVV2 values are generated when the card is issued. The values are calculated by encrypting the bank card number (also known as the primary account number or PAN), expiration date and service code with encryption keys (often called Card Verification Key or CVK) known only to the issuing bank, and decimalizing the result.

Using a credit card generally involves the following transaction steps: authorization, batching, clearing and settlement, and funding.

Authorization: The cardholder pays for the purchase and the merchant submits the transaction to the acquirer (acquiring bank). The acquirer verifies the credit card number, the transaction type and the amount with the issuer (Card-issuing bank) and reserves that amount of the cardholder's credit limit for the merchant. An authorization will generate an approval code, which the merchant stores with the transaction.

Batching: Authorized transactions are stored in “batches”, which are sent to the acquirer. Batches are typically submitted once per day at the end of the business day. If a transaction is not submitted in the batch, the authorization will stay valid for a period determined by the issuer, after which the held amount will be returned back to the cardholder's available credit. Some transactions may be submitted in the batch without prior authorizations; these are either transactions falling under the merchant's floor limit or ones where the authorization was unsuccessful but the merchant still attempts to force the transaction through. (Such may be the case when the cardholder is not present but owes the merchant additional money, such as extending a hotel stay or car rental.)

Clearing and Settlement: The acquirer sends the batch transactions through the credit card association, which debits the issuers for payment and credits the acquirer. Essentially, the issuer pays the acquirer for the transaction.

Funding: Once the acquirer has been paid, the acquirer pays the merchant. The merchant receives the amount totaling the funds in the batch minus either the “discount rate,” “mid-qualified rate”, or “non-qualified rate” which are tiers of fees the merchant pays the acquirer for processing the transactions.

Chargebacks: A chargeback is an event in which money in a merchant account is held due to a dispute relating to the transaction. Chargebacks are typically initiated by the cardholder. In the event of a chargeback, the issuer returns the transaction to the acquirer for resolution. The acquirer then forwards the chargeback to the merchant, who must either accept the chargeback or contest it. A merchant is responsible for the chargeback only if the merchant has violated the card acceptance procedures as per the merchant agreement with card acquirers.

Pretty Good Privacy (PGP) is a data encryption and decryption computer program that provides cryptographic privacy and authentication for data communication. PGP is often used for signing, encrypting and decrypting e-mails to increase the security of e-mail communications. PGP encryption uses a serial combination of hashing, data compression, symmetric-key cryptography, and, finally, public-key cryptography; each step uses one of several supported algorithms. Each public key is bound to a user name and/or an e-mail address. The first version of this system was generally known as a web of trust to contrast with the X.509 system which uses a hierarchical approach based on certificate authority and which was added to PGP implementations later. Current versions of PGP encryption include both options through an automated key management server.

### BRIEF SUMMARY OF THE INVENTION

An object of the invention is to provide a system and method for sending information and feedback requests to customers immediately following a purchase and for returning that information to the merchant that overcome the disadvantages of the systems and methods of this general type and of the prior art.

An object of the invention is to send information or a request for feedback (e.g. a surveyor questionnaire) to a customer immediately after a customer makes a purchase from a merchant using a credit card.

A further object of the invention is to provide a system and method that inherently is vulnerable to hacking by not storing entire credit-card data (i.e. credit-card numbers) on a system server.

With the foregoing and other objects in view there is provided, in accordance with the invention, a method and system for receiving customer feedback from customers using credit cards is provided. A first step of the method includes providing a computer database. The computer database can be a relational database. The data in the computer database is stored in a relation, which is also known as a table. The database includes tuples, also known as rows and attributes, also known as columns. Data elements are stored in the intersection of the tuples and attributes. In the computer database, each data element is associated with a user account. Each tuple includes a credit-card identifier of a credit-card holder. Examples of an electronic message address include an email address, mobile telephone number, pin number, IP address, etc. of a credit-card holder. The credit-card identifier is derived from a credit-card account number of the credit-card holder. The credit card identifier can be a portion of the credit card account number. The credit card identifier should be long enough to limit to a useful amount the number of duplicates credit-card identifiers in the database. Because, the first digits are used to identify credit-card type and the issuing bank, the last digits are more useful. The last ten digits have been found to be a useful credit-card identifier. The credit-card identifier should be more than last four digits of a credit card account number. The last four digits are printed on most receipts and are very available to anyone with a printed receipt; the receipt could be taken from the trash. So, a credit-card identifier based on only the last four digits could be easily compromised.

In addition, the credit-card identifier should be less than the entire credit-card number. In particular, the credit-card identifier should be shorter than the credit-card number less than the bank number and less the last four digits. The fewer digits are included in the credit card identifier, the more secure the credit-card information will be. However, the fewer the number of digits, the less unique each credit-card identifier will be.

A user creates an account. To create an account, a user enters data into the computer database. As a minimum, the user includes a credit-card identifier and electronic messaging address. The credit-card identifier is derived from the credit-card account number of the user but is not the entire credit-card number. The electronic messaging address can be an email address, mobile telephone number, social networking address, IP number, or other address for sending messages to and from. Additional biographical information can be entered into the database. The information can include additional electronic addresses, additional credit-card identifiers, mailing addresses, gender, and address. The user can be asked to include additional marketing information about their interests. A user can be asked if they want to share their purchasing information with other merchants. A user can choose what information they want to share with merchants, can opt out of specific merchants, and adjust other privacy features.

Secondary credit-card information can be included in the database. Secondary information can be biographical information associated with the credit card (e.g. user's name, billing address, or expiration date) that can be combined with the digits in the credit-card identifier to create a unique combination to identify each user in the computerized database.

The next step of the method includes purchasing a good or service from a merchant using a credit card. The credit-card account number is read at the Point-Of-Sale (POS) terminal and the purchase is processed. The POS system reads additional available information from the credit card, usually from the magnetic strip.

Next, a credit-card identifier is derived from the credit-card account number. The credit card processor can process the credit card information or unprocessed information can be passed to an additional system. The processing is preferably not done at the POS system so that the POS systems will not need to be modified or reprogrammed.

In the next step, a message address is identified by searching the computer database for the credit-card identifier. Once the credit-card identifier is identified, the message address(es) related to the credit-card identifier is/are identified.

The next step is transmitting a message regarding the merchant to the message address. The message can be a questionnaire, survey, coupon, receipt, promotion, or thank-you message. The message is sent as quickly as possible. The user is then able to complete a survey while the experience is fresh in the customer's mind. In addition to a survey, the information can include a paperless receipt of the transaction. If the customer promptly completes and returns the survey, the merchant can receive feedback quickly. If a problem exists, the merchant can act promptly to correct the problem. A database of customers and purchasing habits can be built. The data can be used by the merchant and shared with others.

Connections between the credit-card processor and the computerized database can be secured. For example, electronic communications between the credit-card processor and the computerized database can be made with encrypted communications. Pretty Good Privacy (PGP) can be used to secure the communications.

When a messaging address cannot be identified for credit-card information in a given transaction, a hyperlink to a survey is transmitted to the credit-card processor and passed to the POS device. The hyperlink is printed on the receipt. When the customer enters the hyperlink, they are taken to the survey. The survey can include a hyperlink to help the user subscribe to the system. Computer-readable tags and barcodes can be included.

The credit-card identifier can be formed by combining a portion of the credit card number and adding information from another data field stored on the credit card. For example, digits from the credit card could be combined with a name (first and/or last) to create a credit-card identifier. Additional information could include a billing address or zip code read from the credit card.

Because only a portion of a credit card number is used to form the credit-card identifier (i.e. the primary credit-card identifier), a possibility exists for two users to have the same primary credit-card identifier. So, a secondary credit-card identifier can be created to identify the credit card. The secondary credit-card identifier can include a second portion of the credit-card identifier and can be combined with a different piece of account information stored on the credit card.

In instances where two users match a transaction's primary credit-card identifier, a secondary-credit card identifier can be generated and searched to select between the records found matching the primary credit-card identifier.

Again, the goal is to transmit surveys to customers electronically along with a paperless receipt contemporaneously with the processing of the credit card. When the credit card is processed, the merchant with the aid of a POS device with a credit-card reader will send credit card information to a credit card processor. The credit-card processor will submit a credit-card identifier to a computer database. The credit-card identifier can be formed from a subset (i.e. a portion) of the credit card numbers plus additional information read from the credit card (e.g. a first or last name). The credit-card-identifier is related to an electronic message address of the customer.

Based on the search of database, the system will have confirmed if the customer is a registered user who is accepting electronic messages (e.g. SMS messages and email). The system then can send a digital receipt along with a survey that can be emailed directly to the customer. In the scenario that the customer is not registered electronically as identified by that particular credit card, the system has the option to print on the (paper) receipt a method for a obtaining the electronic receipt and take a survey. The survey can include a link to help that customer subscribe to the system.

An object of the invention is to send receipts and surveys from the merchant to the customer. This allows for quick confirmation of transactions. Quick notification of an unauthorized transaction can minimize fraud. If the credit-card holder is notified of an unauthorized transaction, the card holder can notify the bank and suspend the account. The bank can notify the merchant and the merchant can contact the police. Quick feedback can lead to early agreement on a receipt and prevent subsequent charge backs.

An additional object is to provide merchants with customer data such as a message address. This allows the merchant to build a database of customer contact information that can be used for subsequent targeted advertising. Examples of materials that can be sent include coupons, periodic surveys (quarterly, annual), or other communication to customer based on the customer willingness as set through the privacy settings.

A further object of the invention is to provide a database for sending warranty and recall information. In particular, a notice of expiration of a warranty can be sent.

A further object is to sending electronic owners manuals or links to electronic files containing manuals that correspond to products purchased.

The system can be used by merchants to send additional information to customer like contests, promotions, coupons, and survey prizes.

The system can send reports to merchants. For example, customer demographics can be sent. In addition, reports on how many customers are taking surveys can be included.

The system can host digital receipts and surveys for potential new customers for a given time period to allow new customers to subscribe to the system. Then, once the customer is subscribed the stored digital receipts and surveys can be delivered.

The system provides a means to monitor credit card use. If a receipt is delivered electronically to a credit-card holder and the purchase was not authorized by the credit-card holder, then the credit-card holder can contact the issuing bank, report the fraud, and suspend the account.

The system can provide backup receipts to customers. If a paper receipt is lost, the customer can rely on the electronic receipt. Electronic receipts can be stored without requiring physical space.

Electronic receipts are particularly useful because they accumulate in one place. This makes reconciliation with a statement easier. The electronic receipts can be configured to be integrated (for example as XML data) for easy integration with accounting software such as those sold under the trade name QUICKEN or QUICKBOOKS.

Electronic receipts provide detailed information on items purchased for insurance documentation. Electronic receipts stored in the “cloud”; i.e. remotely on a server, are not at risk for loss even if a home or Smartphone is lost or destroyed.

Having the receipts accessible in one place in the cloud allows for easy retrieval of receipts to make returns or exchanges. The stored receipts can be accessed via terminals including portable devices such as a smartphone.

The database can be linked to Web 2.0 websites, in particular, review sites such as Amazon or Yelp to link product or service reviews as a product or service is purchased.

The purchases of food submitted on receipts can be related to the caloric content of the food purchased. The data can be used to track a diet.

The system can provide a user (i.e. customer) web interface. The customer uses an internet browser to view information about their account. Information can be downloaded or linked so other applications on the computer can access the data, in particular, the receipt data.

The system can include Smartphone applications. The Smartphone application includes a means to store the receipts or to link to other applications to fill out reviews with other applications. The application can display purchase information by category and can include summaries. The data can be shared and displayed through various mashups.

Other features that are considered as characteristic for the invention are set forth in the appended claims.

Although the invention is illustrated and described herein as embodied in a method and system for sending surveys and receipts electronically to customers purchasing with credit cards, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a partial diagrammatic and partial schematic view of a system according to the invention.

FIG. 2 is a diagrammatic rear side view of a credit card according to the prior art.

FIG. 3 is a flowchart illustrating a method according to the invention.

### DETAILED DESCRIPTION OF THE INVENTION

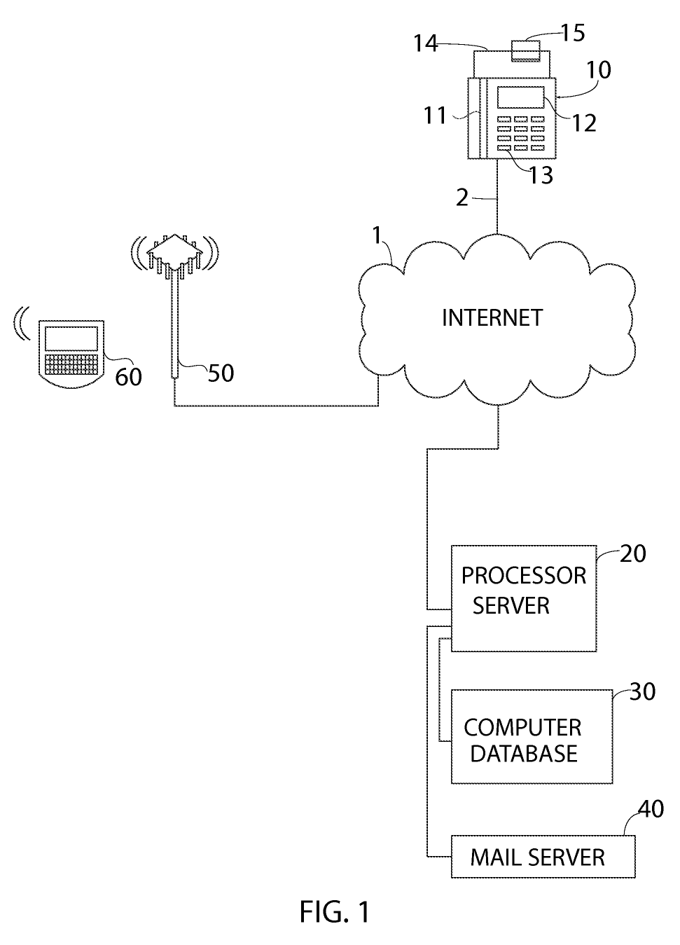

FIG. 1 shows a preferred embodiment of a system according to the invention.

The system includes a point-of-sale (POS) device 10 connected to a credit-card-processor server 20. The credit-card-processor server 20 is connected to a computerized database 30. The computerized database 30 is connected to a message server 40. The message server 40 is connected to a wired-network-to-wireless gateway 50 that transmits messages to a wireless device 60. The preferred embodiments of the components and their connections are detailed below.

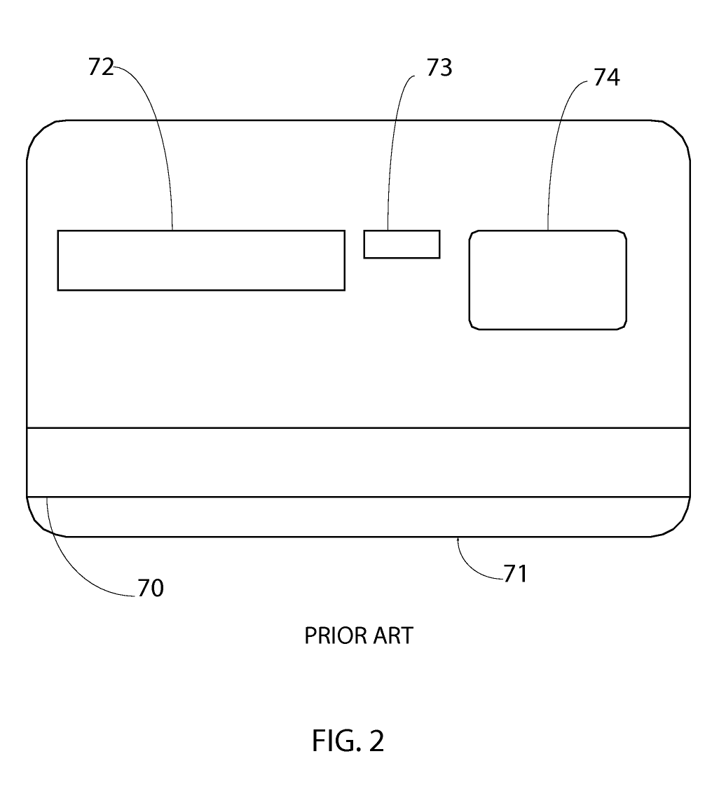

As shown in FIG. 2, a preferred embodiment of a credit card is described in ANSI Standard X4.13-1983. The credit card 70 includes a magnetic strip 71 and a signature panel 72. A card security code panel 73 has a credit card security code (CSC) printed in the panel. The credit card 70 includes a smartcard chip 74.

A preferred embodiment of the POS device 10 is a credit-card processing terminal. The POS device 10 includes a credit-card magnetic strip reader 11 for reading account information from a magnetic strip 71 of a credit card 70 (see FIG. 2). A credit card security code (CSC) 73 is printed on the credit card 70.

The POS device 10 includes a display 12 for displaying messages such as the amount to be submitted, prompts to the operator, and displays messages from the credit-card processor. The POS device 10 includes a keypad 13 for entering data such as the transaction amount, credit-card account information like the billing address and/or zip code, card security code (CSC), and PIN number. The POS device 10 includes a receipt printer 14. The receipt printer 14 prints a receipt on a paper tape 15. The POS device 10 includes a network connector (not shown). Examples of network connectors are sockets for modular phone jacks (RJ11) and Ethernet jacks (RJ45). A cable 2 leading to a network such as a TCP/IP network such as the Internet 1 plugs into the network connector and connects the POS device 10 to the network.

The Internet 1 is a preferred network to connect computers and terminals. The Internet 1 is a global system of interconnected computer networks that use the standard Internet Protocol Suite (TCP/IP).

A credit-card-processor server 20 is connected via the network (e.g. the Internet 1) to the POS device 10. A preferred embodiment of the credit-card-processor server 20 is a computer, or series of computers, that links the POS Device 10 to the computerized database 30 and message server 40. The credit-card-processor server 20 forms connections to the POS Device 10. The credit-card-processor server 20 processes credit-card transactions. The credit-card-processor server 20 receives credit-card account information (e.g. credit-card numbers, expiration dates, billing address, and CSC code) and transaction amounts and returns approvals or declinations to the POS device 10. The credit-card processor 20 records the transaction details for processing and payment and reporting to the client, issuing bank, and payee. The details of a transaction are supplied in later paragraphs. The credit-card-processor server 20 is connected to a computerized database 30. The credit-card-processor server 20 sends credit-card information to the computerized database 30. The computerized database 30 searches for matching records and then returns a related message address to the credit-card processor server. The credit-card-processor server 20 is connected to a message server 40. The credit-card-processor server 20 sends a message and message address to the message server 40.

The computerized database 30 is a relational database. The computerized database 30 includes database management systems (DBMS), the database itself, and search engines. The database 30 includes a set of credit card identifiers. The database 30 also includes a set of message addresses. The credit-card identifiers are related to the message addresses in a one-to-one or one-to-many relationship. The computerized database 30 includes a set of secondary card identifiers. The computerized database 30 is connected to the credit-card-processor server 20 and the message server 40. In a preferred embodiment, the computerized database is hosted on a separate computer or computers than the credit-card-processor server 20.

The message server 40 is connected to the credit-card-processor server 20 and the computerized database 30 and to the Internet 1. The message server 40 sends messages to messaging devices 60 of the credit-card owner. In a preferred embodiment, the message server 40 is a computer email server. Preferred embodiments of messaging devices 60 are wireless telephones and personal computers. In an alternate preferred embodiment, the message server 40 is a SMS server and the messaging device 60 is a wireless telephone. The message server 40 is connected to the Internet 1.

A wired-network-to-wireless-gateway 50 is connected to the Internet 1. A preferred embodiment of the wired-network-to-wireless gateway 50 is a mobile telephone tower. The wired-network-to-wireless gateway 50 receives messages from the message server 40 via the Internet 1 and broadcasts the message to a recipient's message device 60.

The message server 40 receives reply messages sent from the message device 60 of the credit-card owner. The message server 40 can forward the reply message to the merchant. For example, the message can be forwarded to an electronic message address such as an email address, wireless telephone number, or PIN.

A preferred embodiment of the invention is a communication protocol initiated by a POS device 10 to a credit-card processor server 20 running a web based application. The credit-card process server 20, computerized database 30, message server 40, and associated web based applications are a solution that is provided as a service for the merchants and the customers.

A preferred protocol for communication between the POS device 10 and the credit-card-processor server is JSON over https (an acronym for JavaScript Object Notation over Hypertext Transfer Protocol Secure). JSON is a lightweight text-based open standard designed for human-readable data interchange. JSON is derived from the JavaScript programming language for representing simple data structures and associative arrays, called objects. Despite its relationship to JavaScript, JSON is language-independent, with parsers available for virtually every programming language.

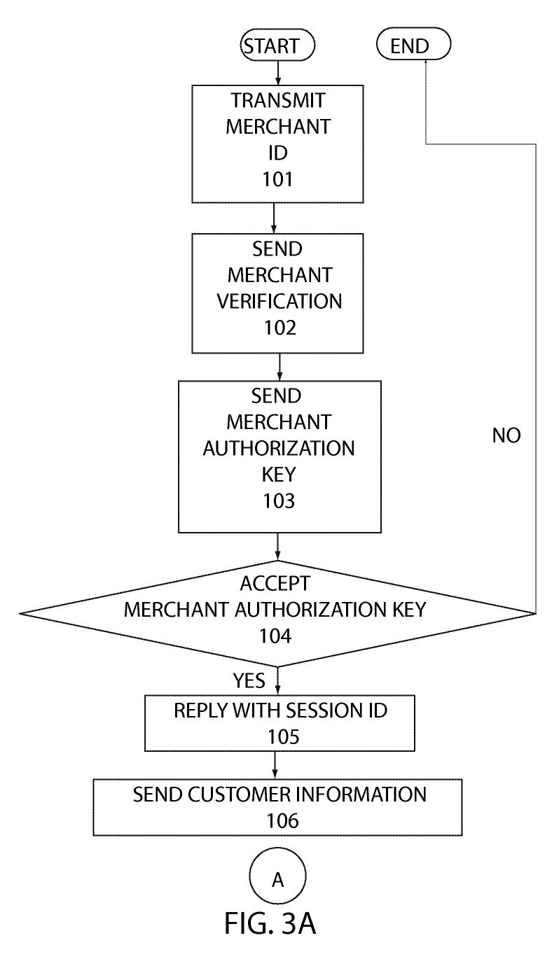

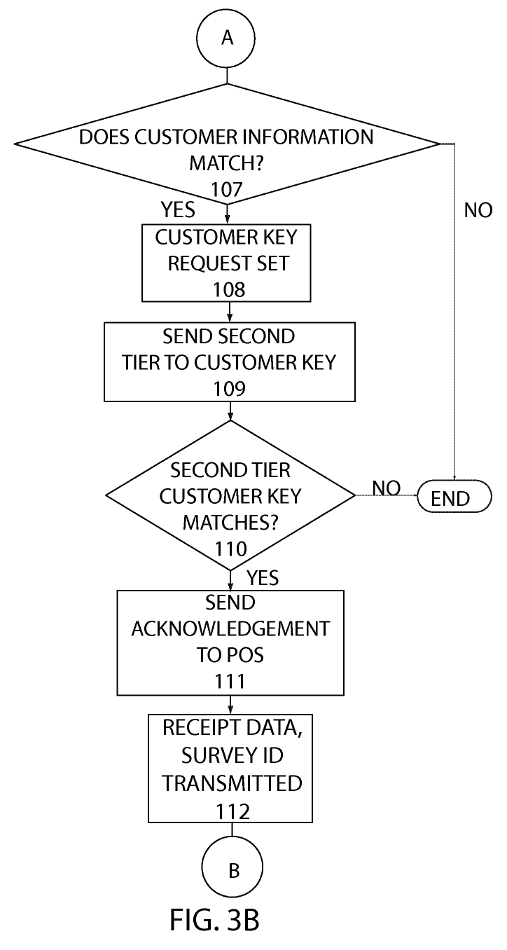

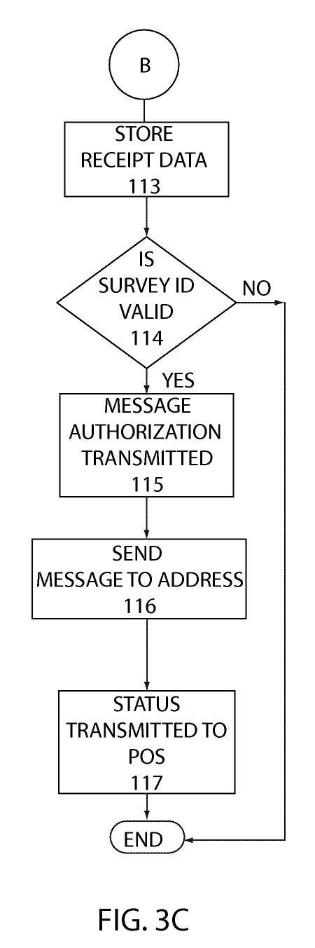

As shown in FIG. 3, to begin a transaction, in step 101, the POS device 10 sends a merchant id to the credit-card-processor server 20 to start a handshake for a new session. A merchant ID is a unique identifier (e.g. number) assigned by a credit card processor to identify a merchant after the merchant has been successfully approved to take credit card purchases. The merchant ID also usually identifies a specific bank account into and out of which credit card funds are transferred.

Next, in step 102, the credit-card-processor server 20 replies with merchant verification using JSON.

Next, in step 103, the POS device 10 replies to the credit-card-processor server 20 with a merchant authorization key. The merchant authorization key is a public key.

Next, in step 104, if the credit-card-processor server 20 accepts the authorization key, the credit-card-processor server 29 replies to the POS device 10 with a session id in step 105.

Next, in step 106, the POS device 10 sends customer information read from the credit card 70 or entered into the POS device 10 to the credit-card-processor server 20.

Next, in step 107, the credit-card-processor server 20 matches the customer information. If the customer information matches a record, in step 108, the credit-card-processor server 20 replies to the POS device 10 with a customer key request.

Next, in step 109, the POS device 10 replies by transmitting a second tier customer key to the credit-card-processor server 20 to satisfy the customer key request.

Next, in step 110, the credit-card-processor server 20 checks the second tier customer key and, in step 111, sends an acknowledgement to the POS device 10 if accepted.

Next, in step 112, the POS System 10 sends receipt data and a survey id to the credit-card-processor server 20.

In step 114, the credit-card-processor server 20 validates the survey id and stores the receipt data in a customer account database in step 113.

In step 115, the credit-card-processor server 20 instructs the message server 40 to send a message to the customer. In step 116, the message server 40 transmits a message to the address. In a preferred embodiment, the message server 40 is an email server; the message sent to the customer is an email. In step 117, the credit-card-processor server 20 replies to the POS device 10 with a status. The status could be, for example, “invalid survey”, “failed_email”, “email_ok”.

The protocol above outlines three pieces: 1) merchant verification, 2) customer verification, and 3) transfer of data. This protocol is designed to protect the customer by not transferring customer information to the merchant over the network. The merchant can communicate further with a customer based on the session id (such as authenticate merchant and send second survey to customer).

The merchant ID (also known as merchant identification) is assigned to a specific merchant after enrolling with the credit-card processor. The merchant ID is a unique integer that is thirty-two (32) bits in length

The merchant key query is: a public key encrypted GUID generated on the server based on the session id that the merchant will be ready to accept to help validate the credit-card-processor server 20. A GUID is a globally unique identifier. A GUID is a special type of identifier used in software applications to provide a unique reference number. The value is represented as a thirty-two character hexadecimal string and usually stored as a 128 bit integer.

An authorization key is the message decrypted using a private key.

A ssession Id is a unique transaction id of the session. A preferred embodiment of a session id is a sixty-four (64) bit integer. A session identifier or session ID or session token is a piece of data that is used in network communications (often over HTTP) to identify a session, a series of related message exchanges. Session identifiers become necessary in cases where the communications infrastructure uses a stateless protocol such as HTTP.

Customer info (or customer information) is a combination of parts of two fields of credit card information. A preferred embodiment of customer info is formed by reading a First Name from the credit card 70 and adding ten (10) digits of the credit card. The customer info is encrypted with a server public key.

A customer_key_query is posed if one or more matches to the decrypted customer info are found in the computerized database 30. The customer key query is sent from the server. The customer info is encrypted with a POS public key.

A customer key is formed with a Last Name of the customer as read from the credit card plus two (2) digits of the credit card. The two digits should not be the last four (4) digits. The customer key is encrypted with a server public key.

Status codes that can be integers correlated to specific messages are transferred to the POS device 10. A status code of “1” corresponds to a “customer ok” status to indicate that the customer (i.e. credit-card owner) is accepting data from the merchant. A status code of “0” (zero) corresponds to “customer invalid” status to indicate the customer is not accepting data from merchants.

The survey-id is an alpha numeric id generated when a merchant adds a survey to the computerized database 30. In an alternate embodiment, the survey can be a link to the merchant's own survey hosted on a remote server. If the survey id is zero (0) or invalid, the survey id is ignored.

Receipt data is a blob of data containing an itemized receipt. In a preferred embodiment, the size of the blob of data is limited to 16K.

Status code is an integer based return code that maps to “1” when email is ok, “2” when email has failed, “3” when the survey is invalid, and “4” when the result is unknown.

A user creates an account in advance. To create an account, a credit-card holder creates a record in the computerized database 30. The record includes a message address. Preferred embodiments of message addresses are email addresses and SMS enabled telephone numbers. The record includes a first portion of a credit card number. The record includes a second portion of the credit card number. Preferably, the first portion is not a subset of the second portion. Likewise, the second portion is not a subset of the first portion. Preferably, the first portion is a ten (10) digit portion of the credit card that does not include the last four (4) digits of the credit card. Preferably, the second portion is the last two (2) digits of the credit card number. In addition, the card holder enters two fields of information from the credit card. Preferred fields are a first name of the card holder and a last name of the card holder. Preferably, the credit card holder does not give the entire credit card number. Preferably, the credit card holder does not give the last four digits of the credit card.

When configuring the account, the user can set privacy settings. The user can allow any receipt to be sent to the message address, no receipt to be sent to the message receipt, or select receipts from a list to be sent; the list can be populated with vendors as the card is used. The user sets if the account information, in particular the message address, can be shared with affiliated vendors.

A preferred embodiment of the method includes the following steps. A credit card owner creates an account with a record in the computer database 30. The credit card owner has a wireless device 60 that is configured to receive messages to the message address in the credit card owner's record in the computer database 30. The credit card customer then purchases goods or services and uses the credit card 70 to pay for the purchase. The credit card is swiped in the POS device 10. The POS device 10 processes the transaction by communicating to the credit-card-processor server 20.

What is claimed is:

1. A method for receiving customer feedback, which comprises:
providing a computerized database including a credit-card identifier of a credit-card holder and an electronic message address of said credit-card holder, said credit-card identifier being derived from a credit-card account number of said credit-card holder, said credit-card identifier being related in said computer database to said electronic message address;
purchasing a good or service from a merchant using a credit card having said credit-card account number;
deriving said credit-card identifier from said credit-card account number;
identifying said electronic message address by searching for said credit-card identifier in said computer database; and
transmitting a survey regarding said merchant to said electronic message address.

2. The method according to claim 1, wherein said credit-card identifier is a portion of said credit-card account number.

3. The method according to claim 1, wherein said credit-card identifier includes said credit-card account number.

4. The method according to claim 1, which further comprises:
providing a credit-card-processor server with a public key and a private key derived from said public key;
connecting said credit-card processor server with said computer database over a private connection;
providing said credit-card account number to a computer of said merchant;
transmitting said public key from said credit-card-processor server to said computer of said merchant;
retaining said private key with said processor only;
encrypting said credit-card identifier using said public key to create an encrypted credit-card identifier;
transmitting said encrypted credit-card identifier to said processor;
decrypting said encrypted credit-card identifier at said processor with said private key.

5. The method according to claim 1, which further comprises sending a receipt for said good or service to said electronic message address.

6. The method according to claim 1, which further comprises:
transmitting a hyperlink to said survey to said computer of said merchant when said credit-card identifier is not related to an electronic message address in said computer database; and
printing said hyperlink on a paper receipt with a printer connected to said computer of said merchant.

7. The method according to claim 1, which further comprises:
submitting an answer to said survey; and
transmitting said answer to said merchant.

8. The method according to claim 1, which further comprises transmitting said survey to said electronic message address when processing said credit card.

9. The method according to claim 1, which further comprises generating said credit card identifier with a credit-card datum stored on said credit card other than said credit-card account number and a portion of said credit-card account number.

10. The method according to claim 9, which further comprises generating said credit card identifier with a first name of said credit-card holder and a string of digits from said credit-card number.

11. The method according to claim 9, which further comprises:
including additional credit card information in said computerized database;
sending a request for said additional credit-card information from said credit-card processor to said computer of said merchant when said credit-card identifier identifies more than one credit-card identifier in said computer database;
generating said additional credit-card information from a second portion of said credit-card number and further credit-card datum stored on said credit card, said further credit-card datum being different than said credit-card datum;
transmitting said additional credit-card information from said computer of said merchant to said credit-card-processor server; and
identifying an electronic message address in said computerized database by searching with said credit-card identifier and said additional credit-card information.

12. The method according to claim 1, wherein said electronic message address is selected from the group consisting of a device identification number, email address, SMS address, MAC address, IP number, and account identifier.

13. The method according to claim 1, which further comprises: reading a credit-card account number from a magnetic strip of said credit card with a POS terminal having a credit-card reader;
generating said credit-card identifier in said credit-card-processor server.

14. The method according to claim 13, which further comprises:
reading a cardholder first name from said magnetic strip of said credit card with said credit-card reader of said POS terminal; and
said deriving of said credit-card identifier utilizes at least a portion of said cardholder first name.

15. A method for receiving customer feedback, which comprises:
transmitting a merchant id from a POS system to a credit-card-processor server;
transmitting customer information from said POS System to said credit-card-processor server;
generating a credit-card identifier from said customer information, said credit-card identifier not including an entire credit-card number;
transmitting said credit-card identifier to a computerized database;
matching said credit-card identifier to an electronic message address related to said customer information; and
sending a message to said electronic message address.

16. The method according to claim 15, wherein said message includes receipt data.

17. The method according to claim 15, which further comprises choosing said message based on said merchant id.

18. The method according to claim 15, which further comprises storing said receipt data in a customer account stored in said credit-card-processor server.

19. The method according to claim 15, wherein said message is selected from the group consisting of a promotion, a survey, and a coupon.

20. The method according to claim 15, wherein said message is an email.
